(19) United States
(12) Patent Application Publication
(10) Pub. No.: US 2009/0301751 A1
(43) Pub. Date: Dec. 10, 2009

(54) NON-HALOGEN FLAME RETARDANT THERMOPLASTIC ELASTOMER RESIN COMPOSITION, METHOD FOR FABRICATING SAME, AND ELECTRIC WIRE AND CABLE USING THE SAME

(75) Inventors: Makoto IWASAKI, Hitachi (JP); Shigehiro MORISHITA, Hitachi (JP)

Correspondence Address: SCULLY SCOTT MURPHY & PRESSER, PC, 400 GARDEN CITY PLAZA, SUITE 300, GARDEN CITY, NY, 11530, US

(73) Assignee: HITACHI CABLE, LTD., Tokyo (JP)

(21) Appl. No.: 12/427,985

(22) Filed: Apr. 22, 2009

(30) Foreign Application Priority Data
Jun. 10, 2008 (JP) 2008-151497
Jun. 10, 2008 (JP) 2008-151498

(51) Int. Cl. H01B 3/30; C08L 67/06; C08K 3/22; C08L 51/06

(52) U.S. Cl. 174/110 SR; 524/523; 524/401; 524/504

(57) ABSTRACT

A non-halogen flame retardant thermoplastic elastomer resin composition includes (A) 30 to 80 parts by weight of an ethylene-methylacrylate copolymer (EMA) containing 30 mass % or more of a methylacrylate or 30 to 80 parts by weight of an ethylene-ethylacrylate copolymer (EEA) containing 15 mass % or more of a ethylacrylate and having a melt flow rate of 0.8 mg/10 min or more; (B) 20 to 70 parts by weight of a thermoplastic polyolefin resin; and (C) 50 to 300 parts by weight of a non-halogen flame retardant agent with respect to 100 parts by weight of the component (A) and the component (B) in total, in which the EMA or EEA is silane-crosslinked.

The present application is based on Japanese Patent Application Nos. 2008-151497 and 2008-151498, the entire contents of which are incorporated herein by reference.

### BACKGROUND OF THE INVENTION

1. Field of the Invention

The present invention relates to a non-halogen flame retardant thermoplastic elastomer resin composition, in which a disperse phase is formed in an olefin system resin matrix by using dynamic crosslinking technique, and more particularly, to a non-halogen flame retardant thermoplastic elastomer resin composition, a method for fabricating the same, and electric wire and cable using the same, which can be processed by high speed extrusion even when a flame retardant agent is filled with high density and show an excellent elongation property, by using a silane-crosslinked ethylene-methylacrylate (EMA) or a silane-crosslinked ethylene-ethylacrylate (EEA) as the disperse phase.

2. Related Art

In recent years, awareness of environmental issues is rising in the world. Also in the field of wire coating material, thermoplastic elastomer resins that do not generate any harmful gas in combustion and are material-recyclable are spreading.

As for the thermoplastic elastomer, various developments are performed till now. For example, Japanese Patent Laid-Open No. 11-228750 (JP-A-11-228750) shows a technique of forming a matrix of the olefin system resin which is originally a fluid component and dispersing an olefin system rubber in the matrix by using the dynamic crosslinking technique.

In general, the non-halogen flame retardant thermoplastic resin to be used in an insulating material for electric wire and cable should be filled with a metal hydroxide such as aluminum hydroxide, magnesium hydroxide with high density.

However, the melt flow property of the flame retardant thermoplastic elastomer resin in which the metal hydroxide is filled with high density is not good. Therefore, a high torque is applied to the flame retardant thermoplastic elastomer resin in extrusion process, so that high-speed extrusion is difficult. In addition, the elongation property is remarkably deteriorated. Further, for the application requiring the heat resistance such as the wire for electronic devices, heat deformation resistance property and cut-through property are improved by crosslinking the flame retardant thermoplastic elastomer resin using the electron beam.

### SUMMARY OF THE INVENTION

Accordingly, the object of the present invention is to provide a non-halogen flame retardant thermoplastic elastomer resin composition, a method for fabricating the same, and electric wire and cable using the same, which can be processed by high speed extrusion even when a flame retardant agent is filled with high density and show an excellent elongation properly, by using a silane-crosslinked EMA or a silane-crosslinked EEA as the disperse phase that is formed in an olefin system resin matrix by using the dynamic crosslinking technique.

According to a first feature of the invention, a non-halogen flame retardant thermoplastic elastomer resin composition comprises:

(A) 30 to 80 parts by weight of an ethylene-methylacrylate copolymer containing 30 mass % or more of a methylacrylate;

(B) 20 to 70 parts by weight of a thermoplastic polyolefin resin; and

(C) 50 to 300 parts by weight of a non-halogen flame retardant agent with respect to 100 parts by weight of the component (A) and the component (B) in total,

in which the ethylene-methylacrylate is silane-crosslinked.

In the non-halogen flame retardant thermoplastic elastomer resin composition, it is preferable that a phase of the component (A) is dispersed in a phase of the component (B).

In the non-halogen flame retardant thermoplastic elastomer resin composition, the component (C) may comprise a metal hydroxide.

According to a second feature of the invention, a method for fabricating a non-halogen flame retardant thermoplastic elastomer resin composition comprising (A) 30 to 80 parts by weight of an ethylene-methylacrylate copolymer containing 30 mass % or more of a methylacrylate, (B) 20 to 70 parts by weight of a thermoplastic polyolefin resin, and (C) 50 to 300 parts by weight of a non-halogen flame retardant agent with respect to 100 parts by weight of the component (A) and the component (B) in total, the method comprises:

copolymerizing a non-crosslinked ethylene-methylacrylate with a silane compound to crosslink the component (A).

The method for fabricating a non-halogen flame retardant thermoplastic elastomer resin composition may further comprise:

graft-copolymerizing the non-crosslinked ethylene-methylacrylate with the silane compound; and

kneading thereafter the graft-copolymerized ethylene-methylacrylate, the component (B), the component (C) and a free radical-generating agent.

Further, an electric wire may comprise an insulator comprising the non-halogen flame retardant thermoplastic elastomer resin composition according to the first feature of the invention.

Still further, a cable may comprise a sheath comprising the non-halogen flame retardant thermoplastic elastomer resin composition according to the first feature of the invention.

According to a third feature of the invention, a non-halogen flame retardant thermoplastic elastomer resin composition comprises:

(A) 30 to 80 parts by weight of an ethylene-ethylacrylate copolymer containing 15 mass % or more of a ethylacrylate and having a melt flow rate of 0.8 mg/10 min or more;

(B) 20 to 70 parts by weight of a thermoplastic polyolefin resin; and

(C) 50 to 300 parts by weight of a non-halogen flame retardant agent with respect to 100 parts by weight of the component (A) and the component (B) in total,

in which the ethylene-ethylacrylate is silane-crosslinked.

In the non-halogen flame retardant thermoplastic elastomer resin composition, it is preferable that a phase of the component (A) is dispersed in a phase of the component (B).

In the non-halogen flame retardant thermoplastic elastomer resin composition, the component (C) may comprise a metal hydroxide.

According to a fourth feature of the invention, a method for fabricating a non-halogen flame retardant thermoplastic elastomer resin composition comprising (A) 30 to 80 parts by weight of an ethylene-ethylacrylate copolymer containing 15 mass % or more of a ethylacrylate and having a melt flow rate of 0.8 mg/10 min or more, (B) 20 to 70 parts by weight of a thermoplastic polyolefin resin, and (C) 50 to 300 parts by weight of a non-halogen flame retardant agent with respect to 100 parts by weight of the component (A) and the component (B) in total, the method comprises:

copolymerizing a non-crosslinked ethylene-methylacrylate with a silane compound to crosslink the component (A).

The method for fabricating a non-halogen flame retardant thermoplastic elastomer resin composition may further comprise:

graft-copolymerizing the non-crosslinked ethylene-ethylacrylate with the silane compound; and

kneading thereafter the graft-copolymerized ethylene-ethylacrylate, the component (B), the component (C) and a free radical-generating agent.

Further, an electric wire may comprise an insulator comprising the non-halogen flame retardant thermoplastic elastomer resin composition according to the third feature of the invention.

Still further, a cable may comprise a sheath comprising the non-halogen flame retardant thermoplastic elastomer resin composition according to the third feature of the invention.

According to the present invention, it is possible to provide a non-halogen flame retardant thermoplastic elastomer resin composition, a method for fabricating the same, and electric wire and cable using the same, which can be processed by high speed extrusion even when the flame retardant agent is filled with high density and show the excellent elongation property.

### BRIEF DESCRIPTION OF THE INVENTION

Next, preferred embodiments according to the invention will be explained in conjunction with appended drawings, wherein:

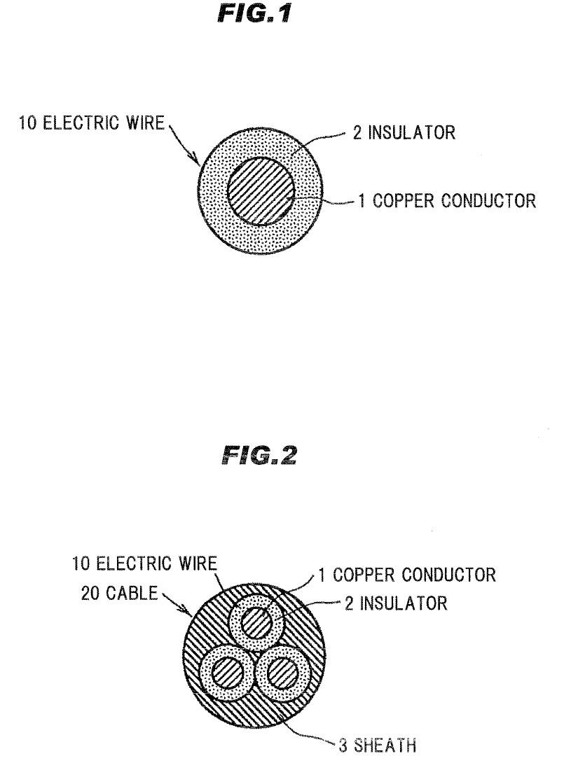

FIG. 1 is a cross sectional view of an electric wire in first and second preferred embodiments according to the invention;

FIG. 2 is a cross sectional view of a cable in the preferred embodiments according to the invention; and

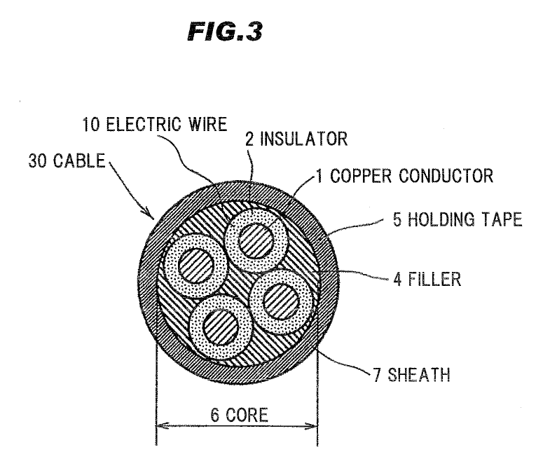

FIG. 3 is a cross sectional view of a cable in a variation of the preferred embodiments according to the invention.

### DETAILED DESCRIPTION OF THE PREFERRED EMBODIMENTS

Next, the preferred embodiments according to the present invention will be explained in more detail in conjunction with the appended drawings.

### (Structure of an Electric Wire and Cables)

Firstly, an electric wire and cables to which the non-halogen flame retardant thermoplastic elastomer resin composition according to the present invention is applied are explained with referring to FIGS. 1 to 3.

FIG. 1 is a cross sectional view of an electric wire 10 comprising a copper conductor 1 coated with an insulator 2 comprising a non-halogen flame retardant thermoplastic elastomer resin composition.

FIG. 2 is a cross sectional view of a cable 20 comprising three stranded electric wires 10 shown in FIG. 1 coated at its outer periphery with a sheath 3 comprising the non-halogen flame retardant thermoplastic elastomer resin composition.

FIG. 3 is a cross sectional view of a cable 30 comprising a core 6 formed by stranding a plurality (four in the drawing) of electric wires 10 shown in FIG. 1 and providing a holding tape 5 therearound via a filler 4, and a sheath 7 comprising the non-halogen flame retardant thermoplastic elastomer resin composition for coating an outer periphery of the core 6.

Each of the insulator 2 and the sheath 3, 7 shown in FIGS. 1 to 3 comprising the non-halogen flame retardant thermoplastic elastomer resin composition is provided as the coating by extrusion.

### First Preferred Embodiment

### JP2008-151497

The non-halogen flame retardant thermoplastic elastomer resin composition in the first preferred embodiment according to the present invention comprises (A) 30 to 80 parts by weight of an ethylene-methylacrylate (EMA) copolymer containing 30 mass % or more of a methylacrylate (MA); (B) 20 to 70 parts by weight of a thermoplastic polyolefin resin; and (C) 50 to 300 parts by weight of a non-halogen flame retardant agent with respect to 100 parts by weight of the component (A) and the component (B) in total) in which the EMA is silane-crosslinked.

In addition, the component (A) comprises a resin composition copolymerized with a silane compound for silane-crosslinking.

The component (A) EMA is crosslinked by the dynamic crosslinking and a phase thereof is dispersed in a phase of the component (B) thermoplastic polyolefin resin.

When the MA contained in the component (A) EMA is less than 30 mass %, a superior flame retardant property cannot be obtained. When the component (A) is less than 30 parts by weight, a sufficient crosslinking is not provided, so that the heat resistance property is deteriorated. When the component (A) is greater than 80 parts by weight, the melt flow property is not good, and the appearance of an extrusion molded product is deteriorated.

In addition, when the component (C) is less than 50 parts by weight with respect to 100 parts by weight of the component (A) and the component (B) in total, the superior flame retardant property cannot be obtained. On the other hand, when the component (C) is greater than 300 parts by weight with respect to 100 parts by weight of the component (A) and the component (B) in total, the mechanical strength is remarkably reduced.

As described above, in the first preferred embodiment, the EMA is used as a material for forming the disperse phase in the olefin system matrix by the dynamic crosslinking technique, so that it is possible to provide the non-halogen flame retardant thermoplastic elastomer resin composition which can be processed by the high speed extrusion even when the flame retardant agent is filled with high density and show the excellent elongation property.

According to the first preferred embodiment, firstly, it is possible to suppress the deterioration in the mechanical property due to the metal hydroxide in the sea phase (thermoplastic polyolefin system resin) other than the disperse phase (island phase), by using the characteristic that the flame retardant agent such as the metal hydroxide is mainly distributed in the disperse phase formed by dynamic crosslinking (the crosslinked EMA). In addition, it is possible to obtain the fluidity in the sea phase, by confining foreign substances in the resin (the flame retardant agent such as the metal hydroxide), which may cause the deterioration in the fluidity, within the disperse phase (island phase). Therefore, it is possible to obtain the excellent extrusion property.

Secondly, it is possible to prevent the deterioration in the extrusion workability due to the crosslinked material while providing a sufficient crosslinking effect for obtaining the heat resistance property, by using the property of the EMA in that the crosslinking is suppressed to some extent since the quantity of the grafted silane in the EMA is less than other ethylene copolymers.

As described above, according to the first preferred embodiment, it is possible to provide the non-halogen flame retardant thermoplastic elastomer resin composition which can be processed with high fluidity and high speed extrusion for the first and second reasons.

The reason why the silane-crosslinking is selected in the present invention will be explained below. In the crosslinking using sulfur, there are disadvantages in that off-flavor is produced in accordance with generation of a sulfur system gas, and that it is difficult to freely determine a color tone of the molded product to be colored. In the crosslinking using an organic peroxide, a polyolefin system resin that is the fluid component is simultaneously crosslinked, so that it is necessary to select a hardly crosslinkable resin as the polyolefin system resin. Therefore, there is a disadvantage in that there is substantially no option but to use a polypropylene that is classified into a hard material.

It is required that the silane compound (silicon analog) has both of a group reactive with the polymer and an alkoxy group forming a crosslink by silanol condensation.

In concrete, vinylsilane compound such as vinyl trimethoxysilane, vinyl triethoxysilane, and vinyltris(β-methoxyethoxy)silane, aminosilane compound such as γ-aminopropyltrimethoxysilane, γ-aminopropyltriethoxysilane, N-β-(aminoethyl) γ-aminopropyltrimethoxysilane, β-(aminoethyl)γ-aminopropylmethyldimethoxysilane, and N-phenyl-γ-aminopropyltrimethoxysilane, epoxy silane compound such as β-(3,4 epoxycyclohexyl)ethyltrimethoxysilane, γ-glycidoxypropyltrimethoxysilane, and γ-glycidoxypropylmethyldiethoxysilane, acrylsilane compound such as γ-methacryloxypropyltrimethoxysilane, polysulfide silane compound such as bis (3-(methacryloxycyril)propyl)propyl)disulfide, and bis(3-(triethoxycyril)propyl)tetrasulfide, and mercaptosilane compound such as 3-mercaptopropyltrimethoxysilane, and 3-mercaptopropyltriethoxysilane may be used.

As a technique for copolymerizing the silane compound, a technique of melt-kneading a predetermined amount of the silane compound and free radical-generating agent in the EMA as a base may be used.

As the free radical-generating agent, the organic peroxide such as dicumyl peroxide may be mainly used.

The additive amount of the silane compound is not specially determined, however, it is preferable that 0.5 to 10.0 parts by weight of the silane compound is added with respect to 100 parts by weight of the EMA to provide a good physical property. When an additive amount of the silane compound is less than 0.5 parts by weight, a sufficient crosslinking effect cannot be provided, so that the strength and the heat resistance property of the composition are deteriorated. When the silane compound as the additive is greater than 10.0 parts by weight, the workability is remarkably deteriorated.

In addition, an optimum amount of the organic peroxide used as the free radical-generating agent is 0.001 to 3.0 parts by weight with respect to 100 parts by weight of the EMA. When the organic peroxide is less than 0.001 parts by weight, the silane compound is not sufficiently copolymerized, so that a sufficient crosslinking effect cannot be obtained. When the organic peroxide is greater than 3.0 parts by weight, the potential of scorch in the EMA is increased.

As the component (C) metal hydroxide, a magnesium hydroxide is most superior in the flame retardant property, however, the present invention is not limited thereto. An aluminum hydroxide or a calcium hydroxide may be also used. In addition, the metal hydroxide that is surface-treated by silane-coupling agent, titanate system coupling agent, aliphatic acid such as stearic acid and calcium stearate, or aliphatic acid metal salt may be used.

As the component (B) thermoplastic polyolefin system resin, known materials may be used. In particular, it is preferable that the thermoplastic polyolefin resin comprises at least one selected from a group consisted of polypropylene, high density polyethylene, linear low-density polyethylene, super low density polyethylene, ethylene-butene-1 copolymer, ethylene-hexene-1 copolymer, ethylene-octene-1 copolymer, ethylene-vinyl acetate copolymer, and ethylene-ethylacrylate copolymer, as alone or a mixture of two or more kinds of the above materials.

When the silane crosslinked components (A), (B) and (C) are kneaded and dynamically crosslinked, it is preferable to add the ethylene-vinyl acetate (EVA) copolymer to which a silanol condensation catalyst such as dicumyl peroxide is kneaded prior to the dynamic crosslinking.

### Second Preferred Embodiment

### JP2008-151498

The non-halogen flame retardant thermoplastic elastomer resin composition in the second preferred embodiment according to the present invention comprises (A) 30 to 80 parts by weight of an ethylene-ethylacrylate (EEA) copolymer containing 15 mass % or more of a ethylacrylate (EA) and having a melt flow rate (MFR) of 0.8 mg/10 min or more; (B) 20 to 70 parts by weight of a thermoplastic polyolefin resin; and (C) 50 to 300 parts by weight of a non-halogen flame retardant agent with respect to 100 parts by weight of the component (A) and the component (B) in total, in which the EEA is silane-crosslinked.

In addition, the component (A) comprises a resin composition copolymerized with a silane compound for silane-crosslinking.

The component (A) EEA is crosslinked by the dynamic crosslinking and a phase of the component (A) is dispersed in a phase of the component (B) thermoplastic polyolefin resin.

When the EA contained in the component (A) EEA is less than 15 mass %, a superior flame retardant property cannot be obtained. When the MFR value is less than 0.8 g/10 min, the melt flow property is bad, so that the appearance of the extrusion molded product is deteriorated. When the component (A) is less than 30 parts by weight, a sufficient crosslinking is not provided, so that the heat resistance property is deteriorated. When the component (A) is greater than 80 parts by weight, the melt flow property is not good, and the appearance of the extrusion molded product is deteriorated.

In addition, when the component (C) is less than 50 parts by weight with respect to 100 parts by weight of the component (A) and the component (B) in total, the superior flame retardant property cannot be obtained. On the other hand, when the component (C) is greater than 300 parts by weight with respect to 100 parts by weight of the component (A) and the component (B) in total, the mechanical strength is remarkably reduced.

As described above, in the second preferred embodiment, the EEA is used as a material for forming the disperse phase in the olefin system matrix by the dynamic crosslinking technique, so that it is possible to provide the non-halogen flame retardant thermoplastic elastomer resin composition which can be processed by the high speed extrusion even when the flame retardant agent is filled with high density and show the excellent elongation property.

According to the second preferred embodiment, firstly, it is possible to suppress the deterioration in the mechanical property due to the metal hydroxide in the sea phase (thermoplastic polyolefin system resin) other than the disperse phase (island phase), by using the characteristic that the flame retardant agent such as the metal hydroxide is mainly distributed in the disperse phase formed by dynamic crosslinking (the crosslinked EEA). In addition, it is possible to obtain the fluidity in the sea phase, by confining foreign substances in the resin (the flame retardant agent such as the metal hydroxide), which may cause the deterioration in the fluidity, within the disperse phase (island phase). Therefore, it is possible to obtain the excellent extrusion property.

Secondly, it is possible to prevent the deterioration in the extrusion workability due to the crosslinked material while providing a sufficient crosslinking effect for obtaining the heat resistance property, by using the property of the EEA in that the crosslinking is suppressed to some extent since the quantity of the grafted silane in the EEA is less than other ethylene copolymers.

As described above, according to the second preferred embodiment, it is possible to provide the non-halogen flame retardant thermoplastic elastomer resin composition which can be processed with high fluidity and high speed extrusion for the first and second reasons.

The reason why the silane-crosslinking is selected is similar to the first preferred embodiment.

As the silane compound, the materials similar to those in the first preferred embodiment may be used.

As a technique for copolymerizing the silane compound, a technique of melt-kneading a predetermined amount of the silane compound and free radical-generating agent in the EEA as a base may be used.

As the free radical-generating agent, the organic peroxide such as dicumyl peroxide may be mainly used.

The additive amount of the silane compound is not specially determined, however, it is preferable that 0.5 to 10.0 parts by weight of the silane compound is added with respect to 100 parts by weight of the EEA to provide a good physical property. When the additive amount of the silane compound is less than 0.5 parts by weight a sufficient crosslinking effect cannot be provided, so that the strength and the heat resistance property of the composition are deteriorated. When the additive amount of the silane compound is greater than 10.0 parts by weight, the workability is remarkably deteriorated.

In addition, an optimum amount of the organic peroxide used as the free radical-generating agent is 0.001 to 3.0 parts by weight with respect to 100 parts by weight of the EEA. When the organic peroxide is less than 0.001 parts by weight, the silane compound is not sufficiently copolymerized, so that a sufficient crosslinking effect cannot be obtained. When the organic peroxide is greater than 3.0 parts by weight, the potential of scorch in the EEA is increased.

As the component (C) metal hydroxide, the materials similar to those in the first preferred embodiment may be used.

As the component (B) thermoplastic polyolefin system resin, the materials similar to those in the first preferred embodiment may be used.

When the silane crosslinked components (A), (B) and (C) are kneaded and dynamically crosslinked, it is preferable to add the ethylene-vinyl acetate (EVA) copolymer to which a silanol condensation catalyst such as dicumyl peroxide is kneaded prior to the dynamic crosslinking.

### EXAMPLES

Samples of non-halogen flame retardant thermoplastic elastomer resin composition in Examples and Comparative Examples were manufactured by a process for graft-copolymerizing a silane compound with EMA or EEA, and a process for kneading the EMA or EEA with which the silane compound is graft-copolymerized, a thermoplastic polyolefin system resin, a metal hydroxide, and a silanol condensation catalyst compounding agent (dicumyl peroxide), so that the EMA or EEA is silane-crosslinked.

In the process for graft-copolymerizing the silane compound with the EMA or EEA, raw materials i.e. the EMA or EEA, vinyl trimethoxysilane, and dicumyl peroxide that are impregnated and mixed in a ratio shown in each item of the component (A) of TABLE 1 to 4 were prepared. The mixture of the raw materials was extruded by using a 40 mm extruder (screw effective length: L/D=24) at a temperature of 200° C. for a staying time of about 5 minutes to perform a graft reaction.

Next, respective components in the combination shown as each example in TABLES 1 to 4 were collectively poured into a 40 mm biaxial extruder (screw effective length: L/D=60) and kneaded therein, and the graft-copolymerized EMA or EEA was crosslinked by the silane compound during the kneading, thereby providing a kneaded material.

A kneading temperature was 180° C. and a screw rotation number was 100 rpm. The kneaded material was palletized to provide a material for manufacturing a cable.

Samples of the cable were manufactured by extrusion-coating a sheath with a thickness of 0.41 mm around a cable core, by using the 40 mm extruder (screw effective length: L/D=24) that was pre-heated at a temperature of 180° C.

The mechanical strength, the heat resistance property, the flame retardant property were evaluated in accordance with Japanese Industrial Standards JISC3005. The sample having a tensile strength of 10 MPa or more and a breaking elongation of 200% or more was evaluated as “accepted (◯)”. The heat resistance property was evaluated by a heat deformation test (a temperature of 75° C. and a load of 10N). The sample in which a decreasing rate for a coating thickness (0.41 mm in the Examples) is 10% or less was evaluated as “accepted (◯)”.

The flame retardant property was evaluated by 60 degrees tilt combustion test, and a fire-spreading time after removing the flame was measured. The sample in which the fire was naturally extinguished within 60 seconds was evaluated as “accepted (◯)”.

Further, so as to confirm the presence of the silane crosslinking, the material was extracted in a hot xylene at a temperature of 110° C. for 24 hours. When a residual insoluble polymer is observed, it was judged as the crosslink is introduced (◯), and when the residual insoluble polymer is not observed, it was judged as the crosslink is not introduced (X). The extrusion workability was evaluated by visual observation of an appearance of the sample at the time of extrusion-molding. When a surface of the sample is smooth, it was evaluated as “good (◯)”, and when the irregularities are generated on the surface, it was evaluated as “bad (x)”.

### Examples and Comparative Examples Using the EMA

TABLE 1
(unit of amount: parts by weight)

| | | Example | | | | | | | |
|---|---|---|---|---|---|---|---|---|---|
| | | Examples | | | | | | | |
| Item | | A1 | A2 | A3 | A4 | A5 | A6 | A7 | A8 |
| Component | A1) EMA | 70 | 80 | — | 30 | 80 | 80 | 80 | 80 |
| (A) | A2) EMA | — | — | 80 | — | — | — | — | — |
| | A3) Vinyl | 1.4 | 1.6 | 1.6 | 0.6 | 1.6 | 1.6 | 0.4 | 8 |
| | trimethoxysilane | | | | | | | | |
| | A4) DCP | 0.007 | 0.008 | 0.008 | 0.003 | 0.008 | 0.008 | 0.008 | 2.4 |
| Component | A5) EVA | 30 | 20 | 20 | 70 | 20 | — | 20 | 20 |
| (B) | A6) HDPE | — | — | — | — | — | 20 | — | — |
| Component | A7) Flame | 200 | 200 | 200 | 50 | 300 | 100 | 200 | 200 |
| (C) | retardant agent | | | | | | | | |
| Catalyst | A8) EVA | 3.45 | 3.45 | 3.45 | 3.45 | 3.45 | 3.45 | 3.45 | 3.45 |
| | A9) DBTDL | 0.18 | 0.18 | 0.18 | 0.18 | 0.18 | 0.18 | 0.18 | 0.18 |
| Evaluation | Tensile Strength | 10.9 | 10.4 | 10.2 | 11.3 | 11.9 | 12.0 | 10.1 | 11.1 |
| | (MPa) | | | | | | | | |
| | Elongation (%) | 240 | 250 | 260 | 240 | 210 | 200 | 290 | 230 |
| | Heat resistance | ◯ | ◯ | ◯ | ◯ | ◯ | ◯ | ◯ | ◯ |
| | Property | | | | | | | | |
| | Flame retardant | ◯ | ◯ | ◯ | ◯ | ◯ | ◯ | ◯ | ◯ |
| | Property | | | | | | | | |
| | Presence of | ◯ | ◯ | ◯ | ◯ | ◯ | ◯ | ◯ | ◯ |
| | Crosslink | | | | | | | | |
| | Extrusion | ◯ | ◯ | ◯ | ◯ | ◯ | ◯ | ◯ | ◯ |
| | workability | | | | | | | | |

A1) EMA: “ACRYFT (trademark) CG2001” (MFR = 0.60 g/10 min, MA = 31%) fabricated by Sumitomo Chemical Co., Ltd.
A2) EMA: “ACRYFT (trademark) CG4002” (MFR = 5.9 g/10 min, MA = 30%) fabricated by Sumitomo Chemical Co., Ltd.
A3) Vinyl trimethoxysilane: “SILA-ACE (trademark) S210” (transparent and colorless liquid) fabricated by Chisso Corporation
A4) DCP (Dicumyl peroxide): “PERCUMYL (trademark) D” (half-period temperature for 1 minute: 179° C.) fabricated by NOF Corporation
A5) EVA (Ethylene-vinyl acetate): “EVAFLEX (trademark) EV560” (MFR = 14 g/10 min, vinyl acetate: VA = 14%) fabricated by Du Pont-Mitsui Polychemicals Co., Ltd.
A6) HDPE (High density polyethylene): “HI-ZEX (trademark) 5000SR” (MFR = 0.37 g/10 min) fabricated by Prime Polymer Co., Ltd.
A7) Non-halogen Flame retardant agent (silane-treated synthetic magnesium hydroxide): “MAGSEEDS (trademark) S-4” fabricated by Konoshima Chemical Co., Ltd.
A8) EVA: “EVAFLEX (trademark) P1007” (MFR = 9 g/10 min, vinyl acetate: VA = 10%) fabricated by Du Pont-Mitsui Polychemicals Co., Ltd.
A9) DBTDL (Dibutyltin dilaurate): “TN-12” fabricated by Sakai Chemical Industry Co., Ltd.

TABLE 2
(unit of amount: parts by weight)

| | | Example | | | | | | |
|---|---|---|---|---|---|---|---|---|
| | | Comparative Examples | | | | | | |
| Item | | B1 | B2 | B3 | B4 | B5 | B6 | B7 |
| Component | B1) EMA | — | — | 80 | — | — | — | — |
| (A) | B2) EMA | 90 | 20 | — | 80 | 80 | — | — |
| | B3) EVA | — | — | — | — | — | 80 | — |
| | B4) HDPE | — | — | — | — | — | — | 80 |
| | B5) Vinyl | 1.8 | 0.4 | 1.6 | 1.6 | 1.6 | 1.6 | 1.6 |
| | trimethoxysilane | | | | | | | |
| | B6) DCP | 0.009 | 0.002 | 0.008 | 0.008 | 0.008 | 0.008 | 0.008 |
| Component | B7) EVA | 10 | 80 | 20 | 20 | 20 | 20 | 20 |
| (B) | | | | | | | | |
| Component | B8) Flame | 200 | 200 | 200 | 450 | 40 | 200 | 100 |
| (C) | retardant agent | | | | | | | |
| Catalyst | B9) EVA | 3.45 | 3.45 | 3.45 | 3.45 | 3.45 | 3.45 | 3.45 |
| | B10) DBTDL | 0.18 | 0.18 | 0.18 | 0.18 | 0.18 | 0.18 | 0.18 |
| Evaluation | Tensile Strength | 11.2 | 11.5 | 10.8 | 10.9 | 10.1 | 10.5 | 13.2 |
| | (MPa) | | | | | | | |
| | Elongation (%) | 210 | 200 | 230 | 80 | 300 | 170 | 40 |
| | Heat resistance | ◯ | X | ◯ | ◯ | ◯ | ◯ | ◯ |
| | Property | | | | | | | |
| | Flame retardant | ◯ | ◯ | X | ◯ | X | ◯ | X |
| | Property | | | | | | | |
| | Presence of | ◯ | X | ◯ | ◯ | ◯ | ◯ | X |
| | Crosslink | | | | | | | |
| | Extrusion | X | ◯ | ◯ | X | ◯ | X | X |
| | workability | | | | | | | |

B1) EMA: MFR = 6 g/10 min, MA = 20%
B2) EMA: “ACRYFT (trademark) CG2001” (MFR = 0.60 g/10 min, MA = 31%) fabricated by Sumitomo Chemical Co., Ltd.
B3) EVA: MFR = 30 g/10 min, VA = 42%
B4) HDPE (High density polyethylene): “HI-ZEX (trademark) 5000SR” (MFR = 0.37 g/10 min) fabricated by Prime Polymer Co., Ltd.
B5) Vinyl trimethoxysilane: “SILA-ACE (trademark) S210” (transparent and colorless liquid) fabricated by Chisso Corporation
B6) DCP (Dicumyl peroxide): “PERCUMYL (trademark) D” (half-period temperature for 1 minute: 179° C.) fabricated by NOF Corporation
B7) EVA (Ethylene-vinyl acetate): “EVAFLEX (trademark) EV560” (MFR = 14 g/10 min, VA = 14%) fabricated by Du Pont-Mitsui Polychemicals Co., Ltd.
B8) Non-halogen flame retardant agent (silane-treated synthetic magnesium hydroxide): “MAGSEEDS (trademark) S-4” fabricated by Konoshima Chemical Co., Ltd.
B9) EVA: “EVAFLEX (trademark) P1007” (MFR = 9 g/10 min, VA = 10%) fabricated by Du Pont-Mitsui Polychemicals Co., Ltd.
B10) DBTDL (Dibutyltin dilaurate): “TN-12” fabricated by Sakai Chemical Industry Co., Ltd.

### Example A1

The respective materials of the component (A), i.e. A1) EMA: “ACRYFT (trademark) CG2001” (MFR=0.60 g/10 min, MA=31%) fabricated by Sumitomo Chemical Co., Ltd., A3) Vinyl trimethoxysilane: “SILA-ACE (trademark) S210” fabricated by Chisso Corporation, and A4) DCP: “PERCUMYL (trademark) D” (half-period temperature for 1 minute: 179° C.) fabricated by NOF Corporation were graft-reacted in a ratio of 70/1.4/0.007 (parts by weight) by the aforementioned kneading process. Then, the component (B), the component (C) and the catalysts are kneaded with the component (A) in a compound ratio shown in TABLE 1. Thereafter, the sample in the Example A1 was evaluated.

As a result, good results were provided in all items of evaluation.

### Example A2

The respective materials of the component (A), i.e. A1) EMA: “ACRYFT (trademark) CG2001”, A3) Vinyl trimethoxysilane: “SILA-ACE (trademark) S210”, and A4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 1. Thereafter, the sample in the Example A2 was evaluated.

As a result, good results were provided in all items of evaluation.

### Example A3

The respective materials of the component (A), i.e. A2) EMA: “ACRYFT (trademark) CG4002” (MFR=5.9 g/10 min, MA=30%) fabricated by Sumitomo Chemical Co., Ltd., A3) Vinyl trimethoxysilane: “SILA-ACE (trademark) S210”, and A4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A in a compound ratio shown in TABLE 1. Thereafter, the sample in the Example A3 was evaluated.

As a result, good results were provided in all items of evaluation.

### Example A4

The respective materials of the component (A), i.e. A1) EMA: “ACRYFT (trademark) CG2001”. A3) Vinyl trimethoxysilane: “SILA-ACE (trademark) S210”, and A4) DCP: “PERCUMYL (trademark) D” were graft-reacted in a ratio of 30/0.6/0.003 (parts by weight) by the aforementioned kneading process. Then, the component (B), the component (C) and the catalysts are kneaded with the component (A) in a compound ratio shown in TABLE 1. Thereafter, the sample in the Example A4 was evaluated.

As a result, good results were provided in all items of evaluation.

### Example A5

The respective materials of the component (A), i.e. A1) EMA: “ACRYFT (trademark) CG2001”, A3) Vinyl trimethoxysilane: “SILA-ACE (trademark) S210”, and A4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 1. Thereafter, the sample in the Example A5 was evaluated.

As a result, good results were provided in all items of evaluation.

### Example A6

The respective materials of the component (A), i.e. A1) EMA: “ACRYFT (trademark) CG2001”, A3) Vinyl trimethoxysilane: “SILA-ACE (trademark) S210” and A4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 1. Thereafter, the sample in the Example A6 was evaluated.

As a result, good results were provided in all items of evaluation.

### Example A7

The respective materials of the component (A), i.e. A1) EMA: “ACRYFT (trademark) CG2001”, A3) Vinyl trimethoxysilane: “SILA-ACE (trademark) S210”, and A4) DCP: “PERCUMYL (trademark) D” were graft-reacted in a ratio of 80/0.4/0.008 (parts by weight) by the aforementioned kneading process. Then, the component (B), the component (C) and the catalysts are kneaded with the component (A) in a compound ratio shown in TABLE 1. Thereafter, the sample in the Example A7 was evaluated.

As a result, good results were provided in all items of evaluation.

### Example A8

The respective materials of the component (A), i.e. A1) EMA: “ACRYFT (trademark) CG2001”, A3) Vinyl trimethoxysilane: “SILA-ACE (trademark) S210”, and A4) DCP: “PERCUMYL (trademark) D” were graft-reacted in a ratio of 80/8/2.4 (parts by weight) by the aforementioned kneading process. Then, the component (B), the component (C) and the catalysts are kneaded with the component (A) in a compound ratio shown in TABLE 1. Thereafter, the sample in the Example A8 was evaluated.

As a result, good results were provided in all items of evaluation.

### Comparative Example B1

The respective materials of the component (A), i.e. B2) EMA: “ACRYFT (trademark) CG2001”, B5) Vinyl trimethoxysilane: “SILA-ACE (trademark) S210”, and B6) DCP: “PERCUMYL (trademark) D” were graft-reacted in a ratio of 90/1.8/0.009 (parts by weight) by the aforementioned kneading process. Then, the component (B), the component (C) and the catalysts are kneaded with the component (A) in a compound ratio shown in TABLE 2. Thereafter, the sample in the Comparative example B1 was evaluated.

In the Comparative example B1, good results were obtained for the items of the tensile strength, the elongation property, the presence of crosslink, the heat resistance property, and the flame retardant property. However, since the component (B) is less (10 parts by weight) than that of the Example A2, a surface of the extrusion-molded product has a rough texture, so that the sample in the Comparative Example B1 was judged as “bad”.

### Comparative Example B2

The respective materials of the component (A), i.e. B2) EMA: “ACRYFT (trademark) CG2001”, B5) Vinyl trimethoxysilane: “SILA-ACE (trademark) S210”, and B6) DCP: “PERCUMYL (trademark) D” were graft-reacted in a ratio of 20/0.4/0.002 (parts by weight) by the aforementioned kneading process. Then, the component (B), the component (C) and the catalysts are kneaded with the component (A) in a compound ratio shown in TABLE 2. Thereafter, the sample in the Comparative example B2 was evaluated.

In the Comparative example B2, good results were obtained for the items of the tensile strength, the elongation property, the flame retardant property, and the extrusion workability. However, since the component (B) is more (80 parts by weight) than that of the Example A4, the residual polymer was not observed for the evaluation of the presence of crosslink. Further, the decreasing rate in the heat deformation test for evaluating the heat resistance property was less than 10%. Therefore, the sample in the Comparative Example B2 was judged as “bad”.

### Comparative Example B3

The respective materials of the component (A), i.e. B1) EMA: MFR=6 g/10 min, MA=20%, B5) Vinyl trimethoxysilane: “SILA-ACE (trademark) S210”, and B6) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 2. Thereafter, the sample in the Comparative example B3 was evaluated.

In the Comparative example B3, good results were obtained for the items of the tensile strength, the elongation property, and the extrusion workability. However, since the MA content in the EMA is low (20%), the flame retardant property was judged as “bad”.

### Comparative Example B4

The respective materials of the component (A), i.e. B2) EMA: “ACRYFT (trademark) CG2001”, B5) Vinyl trimethoxysilane: “SILA-ACE (trademark) S210”, and B6) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 2. Thereafter, the sample in the Comparative example B4 was evaluated.

In the Comparative example B4, since the filling amount of the magnesium hydroxide is more (450 parts by weight) than the Example A5, the elongation was less than 200%. Further, the surface of the extrusion molded product has a rough texture, so that the extrusion workability was judged as “bad”.

### Comparative Example B5

The respective materials of the component (A), i.e. B2) EMA: “ACRYFT (trademark) CG2001”, B5) Vinyl trimethoxysilane: “SILA-ACE (trademark) S210”, and B6) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 2. Thereafter, the sample in the Comparative example B5 was evaluated.

In the Comparative example B5, since the filling amount of the magnesium hydroxide is less (40 parts by weight) than the Example A4, the fire was not naturally extinguished within 60 seconds for the evaluation of the flame retardant property. Therefore, the sample in the Comparative example B5 was judged as “bad”.

### Comparative Example B6

The respective materials of the component (A), i.e. B3) EVA: MFR=30 g/10 min, vinyl acetate: VA=42%, B5) Vinyl trimethoxysilane: “SILA-ACE (trademark) S210”, and B6) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 2. Thereafter, the sample in the Comparative example B6 was evaluated.

In the Comparative example B6, since the EVA was used, a torque applied in the extrusion was higher than those in the Examples A2 and A3, and the melt flows appeared on the surface of the extrusion molded product. Therefore, the extrusion workability was judged as “bad”.

### Comparative Example B7

The respective materials of the component (A), i.e. B4) HDPE (High density polyethylene): “HI-ZEX (trademark) 5000SR” (MFR=0.37 g/10 min) fabricated by Prime Polymer Co., Ltd., B5) Vinyl trimethoxysilane: “SILA-ACE (trademark) S210”, and B6) DC-P: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 2. Thereafter, the sample in the Comparative example B7 was evaluated.

In the Comparative example B7, since the HDPE was used, the silane was not grafted so that the crosslink was not introduced. Therefore, the residual crosslinked polymer was not observed. The fire was not naturally extinguished within 60 seconds, so that the flame retardant property was judged as “bad”. Further, since the surface of the extrusion molded product has a rough surface, the extrusion workability was judged as “bad”.

As clearly shown in the evaluation result, when the flame retardant agent is filled with high density by the dynamic crosslinking technique, without using the EMA as the disperse phase in the olefin system resin matrix, the extrusion torque is increased so that it is difficult to perform the high speed extrusion. In addition, the elongation property is remarkably deteriorated. Accordingly, so as to improve the extrusion workability and the elongation property, it is necessary to use the EMA as the disperse phase.

In addition, it is preferable that a ratio of the EMA in the component (A) to the component (b) is from 80/20 to 20/80. Further, it is confirmed that the flame retardant property and the excellent extrusion workability can be provided by adding 50 to 300 parts by weight of the component (C) the flame retardant agent with respect to 100 parts by weight of the component (A) and the component (B) in total.

### Examples and Comparative Examples Using the EEA

TABLE 3
(unit of amount: parts by weight)

| | | Example | | | | | | | |
|---|---|---|---|---|---|---|---|---|---|
| | | Examples | | | | | | | |
| Item | | C1 | C2 | C3 | C4 | C5 | C6 | C7 | C8 |
| Component | C1) EEA | 60 | 80 | — | 30 | 80 | 80 | 80 | 80 |
| (A) | C2) EEA | — | — | 80 | — | — | — | — | — |
| | C3) Vinyl | 1.2 | 1.6 | 1.6 | 0.6 | 1.6 | 1.6 | 0.4 | 8 |
| | trimethoxysilane | | | | | | | | |
| | C4) DCP | 0.006 | 0.008 | 0.008 | 0.003 | 0.008 | 0.008 | 0.008 | 2.4 |
| Component | C5) EVA | 40 | 20 | 20 | 70 | 20 | — | 20 | 20 |
| (B) | C6) HDPE | — | — | — | — | — | 20 | — | — |
| Component | C7) Flame | 200 | 200 | 200 | 50 | 300 | 100 | 200 | 200 |
| (C) | retardant agent | | | | | | | | |
| Catalyst | C8) EVA | 3.45 | 3.45 | 3.45 | 3.45 | 3.45 | 3.45 | 3.45 | 3.45 |
| | C9) DBTDL | 0.18 | 0.18 | 0.18 | 0.18 | 0.18 | 0.18 | 0.18 | 0.18 |
| Evaluation | Tensile Strength | 11.2 | 10.4 | 10.9 | 11.5 | 11.3 | 12.3 | 10.2 | 11.4 |
| | (MPa) | | | | | | | | |
| | Elongation (%) | 170 | 180 | 170 | 200 | 150 | 150 | 190 | 170 |
| | Heat resistance | ◯ | ◯ | ◯ | ◯ | ◯ | ◯ | ◯ | ◯ |
| | Property | | | | | | | | |
| | Flame retardant | ◯ | ◯ | ◯ | ◯ | ◯ | ◯ | ◯ | ◯ |
| | Property | | | | | | | | |
| | Presence of | ◯ | ◯ | ◯ | ◯ | ◯ | ◯ | ◯ | ◯ |
| | Crosslink | | | | | | | | |
| | Extrusion | ◯ | ◯ | ◯ | ◯ | ◯ | ◯ | ◯ | ◯ |
| | workability | | | | | | | | |

C1) EEA: “ELVALOY (trademark) A-703” (melt flow rate: MFR = 5 g/10 min, ethylacrylate: EA = 25%) fabricated by Du Pont-Mitsui Polychemicals Co., Ltd.
C2) EEA: “REXPEARL (trademark) A1150” (MFR = 0.8 g/10 min, EA = 15%) fabricated by Japan Polyethylene Corporation
C3) Vinyl trimethoxysilane: “SILA-ACE (trademark) S210” (transparent and colorless liquid) fabricated by Chisso Corporation
C4) DCP (Dicumyl peroxide): “PERCUMYL (trademark) D” (half-period temperature for 1 minute: 179° C.) fabricated by NOF Corporation
C5) EVA (Ethylene-vinyl acetate): “EVAFLEX (trademark) EV560” (melt flow rate: MFR = 14 g/10 min, vinyl acetate: VA = 14%) fabricated by Du Pont-Mitsui Polychemicals Co., Ltd.
C6) HDPE (High density polyethylene): “HI-ZEX (trademark) 5000SR” (MFR = 0.37 g/10 min) fabricated by Prime Polymer Co., Ltd.
C7) Flame retardant agent (silane-treated synthetic magnesium hydroxide): “MAGSEEDS (trademark) S-4” fabricated by Konoshima Chemical Co., Ltd.
C8) EVA: “EVAFLEX (trademark) P1007” (MFR = 9 g/10 min, vinyl acetate: VA = 10%) fabricated by Du Pont-Mitsui Polychemicals Co., Ltd.
C9) DBTDL (Dibutyltin dilaurate): “TN-12” fabricated by Sakai Chemical Industry Co., Ltd

TABLE 4
(unit of amount: parts by weight)

| | | Example | | | | | | | |
|---|---|---|---|---|---|---|---|---|---|
| | | Comparative Examples | | | | | | | |
| Item | | D1 | D2 | D3 | D4 | D5 | D6 | D7 | D8 |
| Component | D1) EEA | — | — | 80 | — | — | — | — | |
| (A) | D2) EEA | 90 | 20 | — | — | 80 | 80 | — | — |
| | D3) EEA | — | — | — | 80 | — | — | — | |
| | D4) EVA | — | — | — | — | — | — | 80- | |
| | D5) HDPE | — | — | — | — | — | — | | 80 |
| | D6) Vinyl | 1.8 | 0.4 | 1.6 | 1.6 | 1.6 | 1.6 | 1.6 | 1.6 |
| | trimethoxysilane | | | | | | | | |
| | D7) DCP | 0.009 | 0.002 | 0.008 | 0.008 | 0.008 | 0.008 | 0.008 | 0.008 |
| Component | D8) EVA | 10 | 80 | 20 | 20 | 20 | 20 | 20 | 20 |
| (B) | | | | | | | | | |
| Component | D9) Flame | 200 | 200 | 200 | 200 | 450 | 40 | 200 | 100 |
| (C) | retardant agent | | | | | | | | |
| Catalyst | D10) EVA | 3.45 | 3.45 | 3.45 | 3.45 | 3.45 | 3.45 | 3.45 | 3.45 |
| | D11) DBTDL | 0.18 | 0.18 | 0.18 | 0.18 | 0.18 | 0.18 | 0.18 | 0.18 |
| Evaluation | Tensile Strength | 11.2 | 11.5 | 10.9 | 10.5 | 10.2 | 10.6 | 10.5 | 13.2 |
| | (MPa) | | | | | | | | |
| | Elongation (%) | 170 | 160 | 160 | 180 | 50 | 210 | 170 | 40 |
| | Heat resistance | ◯ | X | ◯ | ◯ | ◯ | ◯ | ◯ | ◯ |
| | Property | | | | | | | | |
| | Flame retardant | ◯ | ◯ | X | ◯ | ◯ | X | ◯ | X |
| | Property | | | | | | | | |
| | Presence of | ◯ | X | ◯ | ◯ | ◯ | ◯ | ◯ | X |
| | Crosslink | | | | | | | | |
| | Extrusion | X | ◯ | ◯ | X | X | ◯ | X | X |
| | workability | | | | | | | | |

D1) EEA: MFR = 5 g/10 min, EA = 9%
D2) EEA: “ELVALOY trademark) A-703” (MFR = 5 g/10 min, EA = 25%) fabricated by Du Pont-Mitsui Polychemicals Co., Ltd.
D3) EEA: MFR = 0.5 g/10 min, EA = 15%
D4) EVA: MFR = 30 g/10 min, vinyl acetate: VA = 42%
D5) HDPE (High density polyethylene): “HI-ZEX (trademark) 5000SR” (MFR = 0.37 g/10 min) fabricated by Prime Polymer Co., Ltd.
D6) Vinyl trimethoxysilane: “SILA-ACE (trademark) S210” (transparent and colorless liquid) fabricated by Chisso Corporation
D7) DCP (Dicumyl peroxide): “PERCUMYL (trademark) D” (half-period temperature for 1 minute: 179° C.) fabricated by NOF Corporation
D8) EVA (Ethylene-vinyl acetate): “EVAFLEX (trademark) EV560” (MFR = 14 g/10 min, VA = 14%) fabricated by Du Pont-Mitsui Polychemicals Co., Ltd.
D9) Flame retardant agent (silane-treated synthetic magnesium hydroxide): “MAGSEEDS (trademark) S-4” fabricated by Konoshima Chemical Co., Ltd.
D10) EVA: “EVAFLEX (trademark) P1007” (MFR = 9 g/10 min, VA = 10%) fabricated by Du Pont-Mitsui Polychemicals Co., Ltd.
D11) DBTDL (Dibutyltin dilaurate): “TN-12” fabricated by Sakai Chemical Industry Co., Ltd

### Example C1

The respective materials of the component (A), i.e. C1) EEA: “ELVALOY (trademark) A-703” (melt flow rate: MFR=5 g/10 min, ethylacrylate: EA=25%) fabricated by Du Pont-Mitsui Polychemicals Co., Ltd., C3) Vinyl trimethoxysilane: “SILA-ACE (trademark) S210” fabricated by Chisso Corporation, and C4) DCP: “PERCUMYL (trademark) D” (half-period temperature for 1 minute: 179° C.) fabricated by NOF Corporation were graft-reacted in a ratio of 60/1.2/0.006 (parts by weight) by the aforementioned kneading process. Then, the component (B), the component (C) and the catalysts are kneaded with the component (A) in a compound ratio shown in TABLE 3. Thereafter, the sample in the Example C1 was evaluated.

As a result, good results were provided in all items of evaluation.

### Example C2

The respective materials of the component (A), i.e. C1) EEA: “ELVALOY (trademark) A-703V”, C3) Vinyl trimethoxysilane: “SILA-ACE (trademark) S210”, and C4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 3. Thereafter, the sample in the Example C2 was evaluated.

As a result, good results were provided in all items of evaluation.

### Example C3

The respective materials of the component (A), i.e. C2) EEA: “REXPEARL (trademark) A1150” (MFR=0.8 g/10 min, EA=15%) fabricated by Japan Polyethylene Corporation, C3) Vinyl trimethoxysilane: “SILA-ACE (trademark) S210”, and C4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 3. Thereafter, the sample in the Example C3 was evaluated.

As a result, good results were provided in all items of evaluation.

### Example C4

The respective materials of the component (A), i.e. C1) EEA: “ELVALOY (trademark) A-703”, C3) Vinyl trimethoxysilane: “SILA-ACE (trademark) S210”, and C4) DCP: “PERCUMYL (trademark) D” were graft-reacted in a ratio of 30/0.6/0.003 (parts by weight) by the aforementioned kneading process. Then, the component (B), the component (C) and the catalysts are kneaded with the component (A) in a compound ratio shown in TABLE 3. Thereafter, the sample in the Example C4 was evaluated.

As a result, good results were provided in all items of evaluation.

### Example C5

The respective materials of the component (A), i.e. C1) EEA: “ELVALOY (trademark) A-703”, C3) Vinyl trimethoxysilane: “SILA-ACE (trademark) S210”, and C4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 3. Thereafter, the sample in the Example C5 was evaluated.

As a result, good results were provided in all items of evaluation.

### Example C6

The respective materials of the component (A), i.e. C1) EEA: “ELVALOY trademark) A-703”, C3) Vinyl trimethoxysilane: “SILA-ACE (trademark) S210”, and C4) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 3. Thereafter, the sample in the Example C6 was evaluated.

As a result, good results were provided in all items of evaluation.

### Example C7

The respective materials of the component (A), i.e. C1) EEA: “ELVALOY (trademark) A-703”, C3) Vinyl trimethoxysilane: “SILA-ACE (trademark) S210”, and C4) DCP: “PERCUMYL (trademark) D” were graft-reacted in a ratio of 80/0.4/0.008 (parts by weight) by the aforementioned kneading process. Then, the component (B), the component (C) and the catalysts are kneaded with the component (A) in a compound ratio shown in TABLE 3. Thereafter, the sample in the Example C7 was evaluated.

As a result, good results were provided in all items of evaluation.

### Example C8

The respective materials of the component (A), i.e. C1) EEA: “ELVALOY (trademark) A-703”, C3) Vinyl trimethoxysilane: “SILA-ACE (trademark) S210”, and C4) DCP: “PERCUMYL (trademark) D” were graft-reacted in a ratio of 80/8/2.4 (parts by weight) by the aforementioned kneading process. Then, the component (B), the component (C) and the catalysts are kneaded with the component (A) in a compound ratio shown in TABLE 3. Thereafter, the sample in the Example C8 was evaluated.

As a result, good results were provided in all items of evaluation.

### Comparative Example D1

The respective materials of the component (A), i.e. D2) EEA: “ELVALOY (trademark) A-703” (MFR=5 g/10 min, EA=25%) fabricated by Du Pont-Mitsui Polychemicals Co., Ltd., D6) Vinyl trimethoxysilane: “SILA-ACE (trademark) S210”, and D7) DCP: “PERCUMYL (trademark) D” were graft-reacted in a ratio of 90/1.8/009 (parts by weight) by the aforementioned kneading process. Then, the component (B), the component (C) and the catalysts are kneaded with the component (A) in a compound ratio shown in TABLE 4. Thereafter, the sample in the Comparative example D1 was evaluated.

In the Comparative example D1, good results were obtained for the items of the tensile strength, the elongation property, the presence of crosslink, the heat resistance property, and the flame retardant property. However, since the component (B) is less (10 pa by weight) that that of the Example C2, a surface of the extrusion-molded product has a rough texture, so that the sample in the Comparative Example D1 was judged as “bad”.

### Comparative Example D2

The respective materials of the component (A), i.e. D2) EEA: “ELVALOY (trademark) A-703”, D6) Vinyl trimethoxysilane: “SILA-ACE (trademark) S210”, and D7) DCP: “PERCUMYL (trademark) D” were graft-reacted in a ratio of 20/0.4/0.002 (parts by weight) by the aforementioned kneading process. Then, the component (B), the component (C) and the catalysts are kneaded with the component (A) in a compound ratio shown in TABLE 4. Thereafter, the sample in the Comparative example D2 was evaluated.

In the Comparative example D2, good results were obtained for the items of the tensile strength, the elongation property, the flame retardant property, and the extrusion workability. However, since the component (B) is more (80 parts by weight) than that of the Example C4, the residual polymer was not observed for the evaluation of the presence of crosslink. Further, the decreasing rate in the heat deformation test for evaluating the heat resistance property was less than 10%. Therefore, the sample in the Comparative Example D2 was judged as “bad”.

### Comparative Example D3

The respective materials of the component (A), i.e. D1) EEA: MFR=5 g/10 min, EA=9% D6) Vinyl trimethoxysilane: “SILA-ACE (trademark) S210”, and D7) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 4. Thereafter, the sample in the Comparative example D3 was evaluated.

In the Comparative example D3, good results were obtained for the items of the tensile strength, the elongation property, and the extrusion workability. However, since the EA content in the EEA is low (9%), the fire was not naturally extinguished within 60 seconds in the evaluation for the flame retardant property, so that the flame retardant property was judged as “bad”.

### Comparative Example D4

The respective materials of the component (A), i.e. D3) EEA: MFR=0.5 g/10 min, EA=15%, D6) Vinyl trimethoxysilane: “SILA-ACE (trademark) S210”, and D7) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 4. Thereafter, the sample in the Comparative example D4 was evaluated.

In the Comparative example D4, since the MFR value is 0.5 g/10 min, good results were obtained for the items of the tensile strength, the presence of crosslink, the heat resistance property, and the flame retardant property. However, a torque applied in the extrusion was higher than those in the Examples C1 to C8, and the melt flows appeared on the surface of the extrusion molded product. Therefore, the extrusion workability was judged as “bad”.

### Comparative Example D5

The respective materials of the component (A), i.e. D2) EEA: “ELVALOY (trademark) A-703” (MFR=5 g/10 min, EA=25%), D6) Vinyl trimethoxysilane: “SILA-ACE (trademark) S210”, and D7) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 4. Thereafter, the sample in the Comparative example D5 was evaluated.

In the Comparative example D5, since the filling amount of the magnesium hydroxide is more (450 parts by weight) than the Example C5, the elongation was less than 150%. Further, the surface of the extrusion molded product has a rough texture, so that the extrusion workability was judged as “bad”.

### Comparative Example D6

The respective materials of the component (A), i.e. D2) EEA: “ELVALOY (trademark) A-703” (MFR=5 g/10 min, EA=25%), D6) Vinyl trimethoxysilane: “SILA-ACE (trademark) S210”, and D7) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 4. Thereafter, the sample in the Comparative example D6 was evaluated.

In the Comparative example D6, since the filling amount of the magnesium hydroxide is less (40 parts by weight) than the Example C4, the fire was not naturally extinguished within 60 seconds in the evaluation of the flame retardant property. Therefore, the sample in the Comparative example D6 was judged as “bad”.

### Comparative Example D7

The respective materials of the component (A), i.e. D4) EVA: MFR=30 g/10 min, vinyl acetate: VA=42%, D6) Vinyl trimethoxysilane: “SILA-ACE (trademark) S210”, and D7) DCP: “PERCUMYL (trademark) D” were graft-reacted in a ratio of 80/1.6/0.008 (parts by weight) by the aforementioned kneading process. Then, the component (B), the component (C) and the catalysts are kneaded with the component (A) in a compound ratio shown in TABLE 4. Thereafter, the sample in the Comparative example D7 was evaluated.

In the Comparative example D7, since the EVA was used, a torque applied in the extrusion was higher than those in the Examples C2 and C3, and the melt flows appeared on the surface of the extrusion molded product. Therefore, the extrusion workability was judged as “bad”.

### Comparative Example D8

The respective materials of the component (A), i.e. D5) HDPE (High density polyethylene): “HI-ZEX (trademark) 5000SR” (MFR=0.37 g/10 min) fabricated by Prime Polymer Co., Ltd., D6) Vinyl trimethoxysilane: “SILA-ACE (trademark) S210”, and D7) DCP: “PERCUMYL (trademark) D” were graft-reacted in a ratio of 80/1.6/0.008 (part by weight) by the aforementioned kneading process. Then, the component (B), the component (C) and the catalysts are kneaded with the component (A) in a compound ratio shown in TABLE 4. Thereafter, the sample in the Comparative example D8 was evaluated.

In the Comparative example D8, since the HDPE was used, the silane was not grafted so that the crosslink was not introduced. Therefore, the residual crosslinked polymer was not observed. The fire was not naturally extinguished within 60 seconds, so that the flame retardant property was judged as “bad”. Further, since the surface of the extrusion molded product has a rough surface, the extrusion workability was judged as “bad”.

As clearly shown in the evaluation result, when the flame retardant agent is filled with high density by the dynamic crosslinking technique, without using the EEA as the disperse phase in the olefin system resin matrix, the extrusion torque is increased so that it is difficult to perform the high speed extrusion. In addition, the elongation property is remarkably deteriorated. Accordingly, so as to improve the extrusion workability and the elongation property, it is necessary to use the EEA as the disperse phase.

In addition, it is preferable that a ratio of the EEA in the component (A) to the component (b) is from 80/20 to 20/80. Further, it is confirmed that the flame retardant property and the excellent extrusion workability can be provided by adding 50 to 300 parts by weight of the component (C) the flame retardant agent with respect to 100 parts by weight of the component (A) and the component (B) in total.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A non-halogen flame retardant thermoplastic elastomer resin composition, comprising:
(A) 30 to 80 parts by weight of an ethylene-methylacrylate copolymer containing 30 mass % or more of a methylacrylate;
(B) 20 to 70 parts by weight of a thermoplastic polyolefin resin; and
(C) 50 to 300 parts by weight of a non-halogen game retardant agent with respect to 100 parts by weight of the component (A) and the component (B) in total,
wherein the ethylene-methylacrylate is silane-crosslinked.

2. The non-halogen flame retardant thermoplastic elastomer resin composition, according to claim 1, wherein a phase of the component (A) is dispersed in a phase of the component (B).

3. The non-halogen flame retardant thermoplastic elastomer resin composition, according to claim 1, wherein the component (C) comprises a metal hydroxide.

4. A method for fabricating a non-halogen flame retardant thermoplastic elastomer resin composition comprising (A) 30 to 80 parts by weight of an ethylene-methylacrylate copolymer containing 30 mass % or more of a methylacrylate, (B) 20 to 70 parts by weight of a thermoplastic polyolefin resin, and (C) 50 to 300 parts by weight of a non-halogen flame retardant agent with respect to 100 parts by weight of the component (A) and the component (B) in total,
the method comprising:
copolymerizing a non-crosslinked ethylene-methylacrylate with a silane compound to crosslink the component (A).

5. The method for fabricating a non-halogen flame retardant thermoplastic elastomer resin composition according to claim 4, further comprising:
graft-copolymerizing the non-crosslinked ethylene-methylacrylate with the silane compound; and
kneading thereafter the graft-copolymerized ethylene-methylacrylate, the component (B), the component (C) and a free radical-generating agent.

6. An electric wire comprising:
an insulator comprising the non-halogen flame retardant thermoplastic elastomer resin composition according to claim 1.

7. A cable comprising:
a sheath comprising the non-halogen flame retardant thermoplastic elastomer resin composition according to claim 1.

8. A non-halogen flame retardant thermoplastic elastomer resin composition, comprising:
(A) 30 to 80 parts by weight of an ethylene-ethylacrylate copolymer containing 15 mass % or more of a ethylacrylate and having a melt flow rate of 0.8 mg/10 min or more:
(B) 20 to 70 parts by weight of a thermoplastic polyolefin resin; and
(C) 50 to 300 parts by weight of a non-halogen flame retardant agent with respect to 100 parts by weight of the component (A) and the component (B) in total,
wherein the ethylene-ethylacrylate is silane-crosslinked.

9. The non-halogen flame retardant thermoplastic elastomer resin composition, according to claim 8, wherein a phase of the component (A) is dispersed in a phase of the component (B).

10. The non-halogen flame retardant thermoplastic elastomer resin composition, according to claim 8, wherein the component (C) comprises a metal hydroxide.

11. A method for fabricating a non-halogen flame retardant thermoplastic elastomer resin composition comprising (A) 30 to 80 parts by weight of an ethylene-ethylacrylate copolymer containing 15 mass % or more of a ethylacrylate and having a melt flow rate of 0.8 mg/10 min or more, (B) 20 to 70 parts by weight of a thermoplastic polyolefin resin, and (C) 50 to 300 parts by weight of a non-halogen flame retardant agent with respect to 100 parts by weight of the component (A) and the component (B) in total,
the method comprising:
copolymerizing a non-crosslinked ethylene-methylacrylate with a silane compound to crosslink the component (A).

12. The method for fabricating a non-halogen flame retardant thermoplastic elastomer resin composition according to claim 11, further comprising:
graft-copolymerizing the non-crosslinked ethylene-ethylacrylate with the silane compound; and
kneading thereafter the graft-copolymerized ethylene-ethylacrylate, the component (B), the component (C) and a free radical-generating agent.

13. An electric wire comprising:
an insulator comprising the non-halogen flame retardant thermoplastic elastomer resin composition according to claim 8.

14. A cable comprising:
a sheath comprising the non-halogen flame retardant thermoplastic elastomer resin composition according to claim 8.
